(19) United States
(12) Patent Application Publication
(10) Pub. No.: US 2012/0314820 A1
(43) Pub. Date: Dec. 13, 2012

(54) High-Performance Orthogonal Frequency Division Multiplexing Receiver

(76) Inventors: Chunmei KANG, Maple Grove, MN (US); Elliot Sheldon Briggs, Lubbock, TX (US); Amitkumar Mane, Chatsworth, CA (US); Brian Steven Nutter, Lubbock, TX (US); Daniel Perrine McLane, Bell Canyon, CA (US)

(21) Appl. No.: 13/488,839

(22) Filed: Jun. 5, 2012

Related U.S. Application Data
(60) Provisional application No. 61/494,827, filed on Jun. 8, 2011.

(51) Int. Cl. H04L 25/08; H04L 27/06

(52) U.S. Cl. 375/344; 375/346

(57) ABSTRACT

Devices, methods, and systems for an orthogonal frequency division multiplexing (OFDM) receiver comprising a processor configured to execute a maximum likelihood timing estimator for OFDM symbol timing, a resampling filter for sampling clock frequency offset correcting via a loop filter, where the loop filter may be configured to receive a symbol timing loop error and provide, via a delay accumulator input signals to the resampling filter, and where the resampling filter may be configured to output a resampled signal for demodulating.

### CROSS-REFERENCE TO RELATED APPLICATION

This application claims priority to and the benefit of U.S. Provisional Patent Application Ser. No. 61/494,827, filed Jun. 8, 2011, which is hereby incorporated herein by reference in its entirety for all purposes.

### FIELD OF ENDEAVOR

Embodiments of the present invention relate to an Orthogonal Frequency Division Multiplexing (OFDM) receiving system, and more particularly, to an OFDM receiving scheme for receiving an orthogonal frequency division multiplexing (OFDM) signal, performing synchronization and demodulating the OFDM signal.

### BACKGROUND

A modulation scheme termed an orthogonal frequency division multiplexing (OFDM) is used in a modulation or demodulation system to carry multiple signals simultaneous over the same transmission path. The OFDM system is a system that provides a large number of orthogonal sub-carriers in a transmission band, allocate data to respective sub-carriers, and digitally modulate a signal according to the modulation scheme such as Phase Shift Keying (PSK) or Quadrature Amplitude Modulation (QAM).

Orthogonal Frequency Division Multiplexing (OFDM) is a highly spectrally efficient modulation scheme, that uses a set of closely-spaced orthogonal sub-carriers to carry data. One problem in an OFDM system is its vulnerability to frequency errors. The frequency errors destroy the orthogonality between subcarriers, resulting in inter-carrier interference (ICI). There are many sources that can cause frequency errors, including carrier frequency offset (CFO) and sampling clock (frequency) offset (SCO) between the transmitter and the receiver. Carrier frequency offset affects each subcarrier the same way, while SCO induced frequency error is subcarrier dependent. The error is more severe for subcarriers that are away from the center frequency. In an OFDM receiving system, different levels of synchronization must be performed to correct these errors before the OFDM signal can be effectively demodulated.

### SUMMARY

Embodiments of a high performance sample clock offset, symbol timing, and frequency offset estimator for a receiver are described herein. An orthogonal frequency division multiplexing (OFDM) receiver system comprising: (a) a processor configured to execute a maximum likelihood timing estimator for OFDM symbol timing; (b) a resampling filter for sampling clock frequency offset correcting via a loop filter, where the loop filter is configured to receive a symbol timing loop error and provide, via a delay accumulator input signals to the resampling filter; and (c) where the resampling filter is configured to output a resampled signal for demodulating. The orthogonal frequency division multiplexing (OFDM) receiver system may further comprise backoff compensator configured to attenuate inter-symbol interference in a noisy environment; and an OFDM signal demodulator. The processor of the orthogonal frequency division multiplexing (OFDM) receiver system may be further configured to execute a maximum likelihood timing estimator for carrier frequency synchronization. Accordingly, the sampling clock frequency offset compensation of the several embodiments tracks the clock offset and resamples the signal.

The exemplary embodiments of a receiver architecture, that performs complete OFDM signal synchronization and demodulation is disclosed herein by example a high performance sample clock synchronizer of a receiver—without considerably increased hardware complexity over the state of the art. The essential components of the receiver design include a Maximum Likelihood estimator for OFDM symbol timing and carrier frequency synchronization, a resampling filter for SCO correction, a backoff compensator to avoid inter-symbol interference (ISI), and an OFDM signal demodulator. The entire synchronization procedure operates in the time domain, and uses the redundancy of the OFDM signal only to detect the error signals. No frequency domain information and pilot symbols are required. Using the proposed receiver design, improved reception quality and wider acquisition range of SCO and CFO may be achieved over the existing state of the art. The receiver performance is robust even under severe environments, including additive white Gaussian noise (AWGN) and multipath interference. The self-synchronous mechanism and wider acquisition range of the proposed receiver greatly relaxes the receiver tolerance restriction on the signal characteristic and hardware components, which has the potential of reducing the overall receiver cost.

Embodiments of the receiver comprise a high performance OFDM receiver design that may be configured to be completely self-synchronous, and to use the center point (CP) of the OFDM signal only to perform CFO, SCO, and symbol clock offset correction in the time domain. In some embodiments, no frequency domain information or aid of pilots may be required.

The ML estimator to the symbol clock and frequency offset and listed in equations 1 and 2 (Eq. (1)-(2)) may be implemented in the exemplary receiver embodiment without modification. The ML timing estimate may involve computation of the correlation γ, SNR, and the energy term, |∈|, in the log-likelihood function 2|γ(θ)|−ρ∈(θ). In each OFDM symbol duration, the argmax of the log-likelihood function indicates the start of the OFDM symbol. The phase of the correlation peak

$$- \frac{1}{2 π} ∠γ ( {\hat{θ}}_{ML} )$$

gives the ML estimate of the frequency offset. The timing offset may be compensated by adjusting the start position of the timing window, while the CFO may be compensated by modulating a frequency correction to the received signal.

The SCO may be jointly estimated from the symbol timing offset estimate. Any algorithm that provides reliable OFDM symbol timing may be used to correct the SCO. The symbol timing offset may drift over time due to mismatched sample clock frequency, and from the time evolution of the drift, the SCO may be measured. If the transmitter and receiver share the same clock, the receiver perceives the same time scale as the transmitter, and thus the symbol timing error is always constant (or zero). If the receiver has a faster clock than the transmitter, then the reference point may keep shifting, or drifting, to an increasingly earlier time from the actual timing window; thus, symbol timing error increases linearly in the positive direction in time, and the increment ratio is proportional to the SCO. If the receiver sample clock is instead slower than the transmitter sample clock, the symbol timing error steadily linearly increases in the negative direction in time.

### BRIEF DESCRIPTION OF THE DRAWINGS

The present embodiments are illustrated by way of example and not limitation in the figures of the accompanying drawings, and in which:

FIG. 1 is a functional block diagram of a conventional implementation of a baseband OFDM transmitter and receiver;

FIG. 2A depicts the effect of the OFDM timing window drift due to unequal sampling frequencies as perceived by the transmitter;

FIG. 2B depicts the effect of the OFDM timing window drift as sampled at the receiver without SCO;

FIG. 2C depicts the effect of the OFDM timing window drift as sampled at the receiver with a faster clock;

FIG. 2D depicts the effect of the OFDM timing window drift as sampled at the receiver with a slower clock;

FIG. 3 shows a plot of the SNR degradation as a function of the subcarrier index;

FIG. 4 is a functional block diagram of an exemplary embodiment of the correction achieved with a control loop;

FIG. 5 depicts a functional block diagram of an exemplary OFDM receiver architecture embodiment;

FIG. 6 is an exemplary graph depicting a demodulated OFDM symbol without SCO correction;

FIG. 7 is an exemplary graph depicting a demodulated OFDM symbol with SCO correction;

FIG. 8 is a graphical depiction of the SCO compensation performance as a function of channel; and

FIG. 9 shows the BER performance of the exemplary receiver.

### DETAILED DESCRIPTION

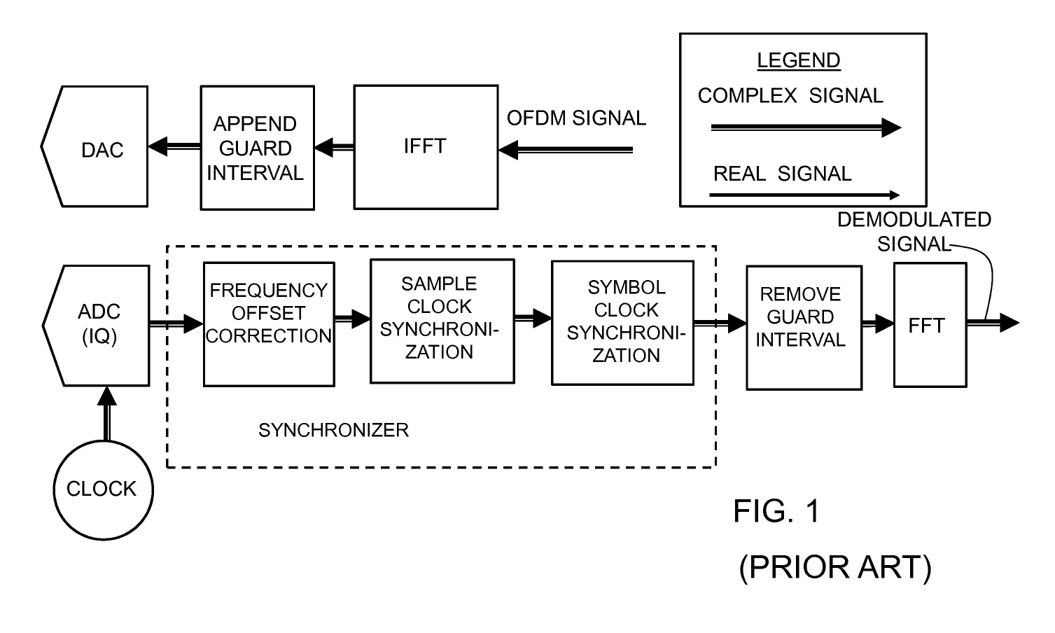

FIG. 1 depicts, in a functional block diagram, a conventional implementation of a baseband OFDM transmitter and receiver. OFDM modulation and demodulation may be efficiently implemented using an inverse fast Fourier transform (IFFT) and a fast Fourier transform (FFT), respectively. The set of subcarriers generated by one transform defines an OFDM symbol. In OFDM modulation, the OFDM symbol is converted to time samples for transmission. A guard interval may be inserted prior to each transform window to mitigate inter-symbol interference (ISI). An effective form of guard interval may be the cyclic prefix (CP), which is a copy of the trailing portion of a given OFDM symbol that is prepended to that symbol. The transform window together with the CP duration defines the OFDM symbol duration. There are a total of P=L+N samples in one OFDM symbol duration, where L indicates the number of samples included in each CP, and N indicates the FFT size.

In an OFDM receiving system, the receiver may be first synchronized with the transmitter to recover the transmitted OFDM signal. CP is then removed from the recovered OFDM signal, and the time samples within the OFDM transform window are converted back to the frequency domain for symbol demapping. Different synchronizations are required in the receiver including carrier frequency offset (CFO) correction, sample clock offset (SCO) synchronization, and symbol clock synchronization. CFO correction may be used to compensate the frequency impairment caused by the mismatch between local oscillators of transmitter and receiver, and Doppler shift. SCO correction is to compensate the mismatch of the crystal oscillators between the transmitter and the receiver. In some embodiments, the symbol clock (timing) synchronization is to find the start of an OFDM symbol.

Errors attributable to frequency offset and symbol timing offset estimate may be compensated. Compensation of these errors may be done with the aid of pilots known to the receiver or with the information provided by the OFDM signal itself. A joint Maximum Likelihood (ML) estimator may be employed to estimate both the symbol timing and carrier frequency offset simultaneously using the redundancy introduced by the CP of the OFDM symbols. This ML technique, as a method or process, is favored both due to its optimal performance and its self-synchronous mechanism. The method uses the correlation between the identical data blocks, which are the CP and the last L samples of the OFDM symbol, to estimate the time and frequency offset. The ML estimate of timing offset (θ) and frequency offset (∈) may be summarized in equations 1 and 2 as follows:

$$\begin{matrix}{\hat{θ}}_{ML} = arg {max}_{θ} \{ 2 \vert γ ( θ ) \vert - ρ ɛ ( θ ) \} & ( 1 ) \\ {\hat{ɛ}}_{ML} = - \frac{1}{2 π} ∠γ ( {\hat{θ}}_{ML} ) \\ where \\ γ ( m ) ≡ {\sum }_{k = m}^{m + L - 1} r ( k ) r * ( k + N ) , \\ ɛ ( m ) ≡ {\sum }_{k = m}^{m + L - 1} {\vert r ( k ) \vert}^{2} + {\vert r ( k + N ) \vert}^{2} , \\ ρ = \frac{SNR}{SNR + 1} ; & ( 2 )\end{matrix}$$

and where r is the received sampled baseband input signal, and “SNR” is the “signal-to-noise ratio.” The ML estimate contains two parts: the correlation γ which correlates r with a delayed version of this signal; and a part that compensates for the difference in energy in the correlated samples.

For ease of implementation, some simplification may be performed when exploiting this technique, for example, using the correlation term only to compute the timing offset,

$${\hat{θ}}_{ML} = arg {max}_{θ} \{ 2 {\vert γ ( θ ) \vert}^{2} \} , or as presented in [ 7 ] , \\ {\hat{θ}}_{ML} = arg {max}_{θ} \{ \vert Re \{ λ \} \vert + \vert Im \{ γ \} \vert \} . \qquad ( 3 )$$

However, in one embodiment, any simplification may be at the cost of performance degradation. The challenge of sample clock synchronization is the least visited topic in the OFDM synchronizer, where OFDM symbol timing may be affected by SCO.

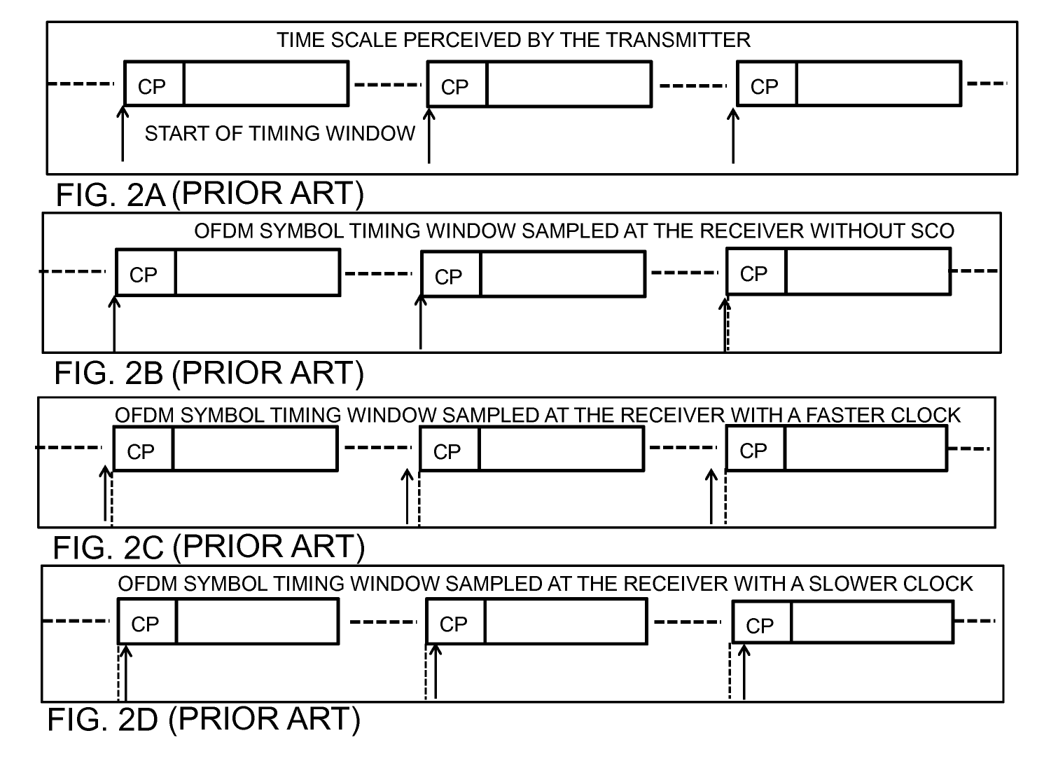

FIGS. 2A-2D depict the effect of the OFDM timing window drift due to unequal sampling frequencies. FIG. 2A depicts the effect of the OFDM timing window drift as perceived by the transmitter. FIG. 2B depicts the effect of the OFDM timing window drift as sampled at the receiver without SCO. FIG. 2C depicts the effect of the OFDM timing window drift as sampled at the receiver with a faster clock. FIG. 2D depicts the effect of the OFDM timing window drift as sampled at the receiver with a slower clock, where the “up” arrows mark the start point of the reference timing window. The interval between adjacent arrows, i.e., between adjacent reference points, is the OFDM symbol duration observed by the receiver. Over time, the perceived OFDM timing window by the receiver drifts from the actual timing window. This translates to a stretching or compressing of the symbol spectral, i.e., spectrum of the OFDM symbol, resulting in subcarrier dependent intercarrier interface (ICI). For inner subcarriers that are proximal to the center frequency in the transmission bandwidth, the frequency errors are minimal, while for outer subcarriers that are distal from the center frequency, the frequency errors may become larger. As the subcarrier spacing is reduced and the number of subcarriers is increased, the frequency errors caused by SCO may become larger.

The effect of SNR degradation caused by SCO may be illustrated where the degradation of SNR in dB on the received signal r for each n^{th} subcarrier index is defined, in equation 4, by

$${D}_{n} \approx 10 {log}_{10} ( 1 + \frac{1}{3} \frac{{E}_{s}}{{N}_{o}} {( π n {10}^{- 6} Δ {f}_{s} )}^{2} ) , \qquad ( 4 )$$

where n is subcarrier index, Eₛ is the received symbol energy, Nₒ is noise energy, and Δfₛ is the SCO in unit of parts per million (ppm).

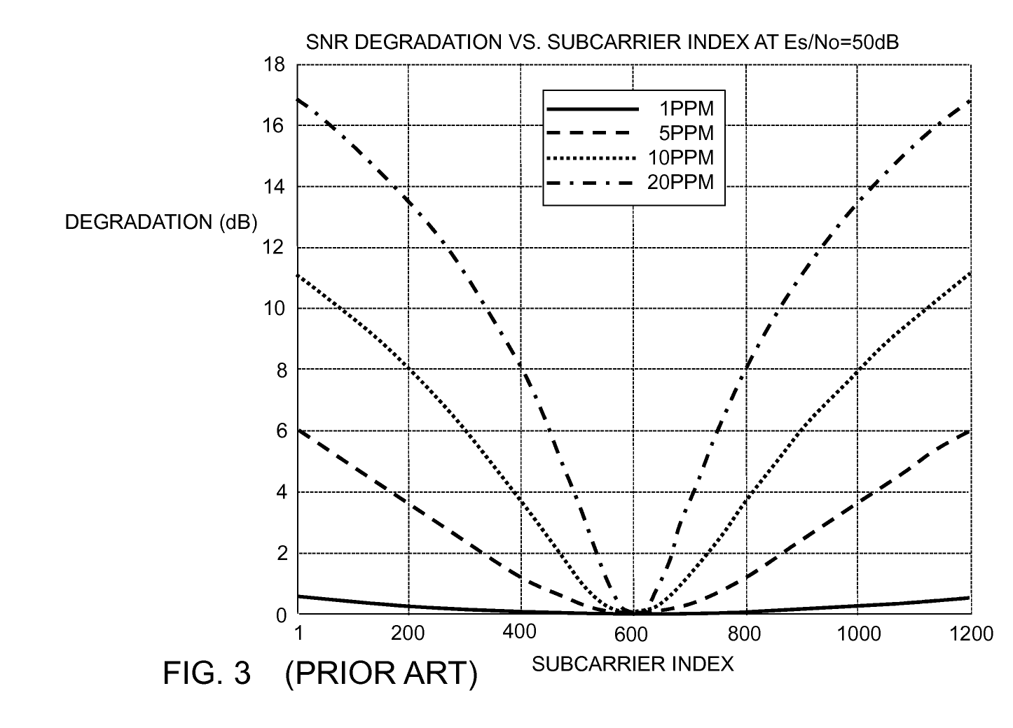

FIG. 3 plots the SNR degradation Dₙ as a function of the subcarrier index [1˜1200] for different clock offset, assuming Eₛ/Nₒ=50 dB. Subcarrier 601 corresponds to the center frequency. FIG. 3 shows that for high Eₛ/Nₒ (symbol energy to noise spectral density ratio), signal quality is adversely affected by even small amounts of sample clock offset. With 20 ppm clock offset between the transmitter and receiver sample clock, SNR degradation may be more than 15 dB at the outer subcarriers.

For user equipment (UE) to provide acceptable performance, SCO needs to be compensated at the receiver so that SCO-related ICI is eliminated. Reported sample clock synchronization schemes include using structures based on interpolation filter, or over sampled frequency clock, both at the expense of increased processing and implementation complexity. A technique to estimate SCO from the time evolution of the timing window, as illustrated in FIG. 2, may be applied. The estimated SCO may then be converted to phase shift values for each subcarrier through a look-up table, and the SCO is compensated by applying these phase shift values to the demodulated signals in the frequency domain. However, the performance of this technique is directly related to the resolution of the look-up-table, which may be the limiting factor of the accuracy of the proposed algorithm.

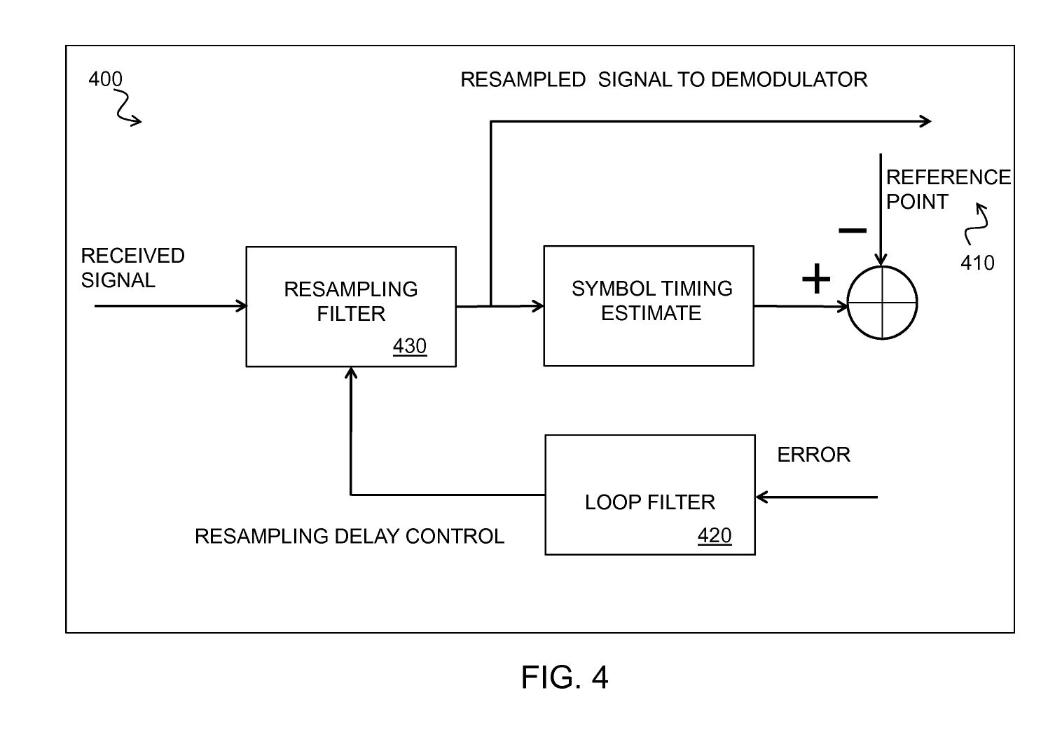

FIG. 4 depicts a functional block diagram of a control loop 400 in an OFDM system. In one embodiment, the symbol timing error may be linearly related to the amount of SCO and its direction, and therefore may be used to correct the SCO. The control loop 400 may be used to resample the received signal at the corrected sample clock. An exemplary embodiment of the correction may be achieved with the control loop 400 as shown in FIG. 4. Symbol timing error measures the time delay between the actual OFDM timing window and the reference point 410. If SCO exists, the time delay value becomes non-zero and keeps increasing with a positive or negative sign, depending on the sign of the SCO. This delay value may be used by the loop filter 420 to determine the amount of observed delay change from the SCO. The loop filter 420 may produce a control signal that estimates the SCO. This control signal drives the resampling filter 430 to increase or reduce the sample delay continuously at a ratio equal to the value of the delay control signal in an effort to reduce the symbol timing error. The resulted effect may delay each received sample by a controlled amount of time, and the overall resampled timing window moves toward the reference point 410. When the time delay to each sample matches the sampling time delay between the transmitter and receiver, the resampled signal matches the transmitted signal just as if the received signal is being sampled by the transmitted sample clock. Accordingly, the transmitted sample clock may be recovered. The resampled timing window may completely aligned with the transmitted timing window reference point 410. After the loop stabilizes, the error signal regulates to zero steady-state, indicating no timing window offset, and the loop filter 420 output remains constant and is proportional to the SCO. The resampled signal, therefore, may become SCO free.

To correct the SCO, the added complexity to the hardware may be a resampling filter 430 and a loop filter 420, which may take a relatively small area in a FPGA device, for example, Xilinx Virtex 5™. The ML estimator of the exemplary embodiments may be employed to jointly estimate all of the synchronization signals including the SCO, CFO, and symbol timing offset. Since this estimator may be implemented as an optimal estimator, it ensures a high receiver performance, although any source of symbol times may be used. In an alternative embodiment, symbol times may be calculated, for example, by a processor, using a least squares timing estimator.

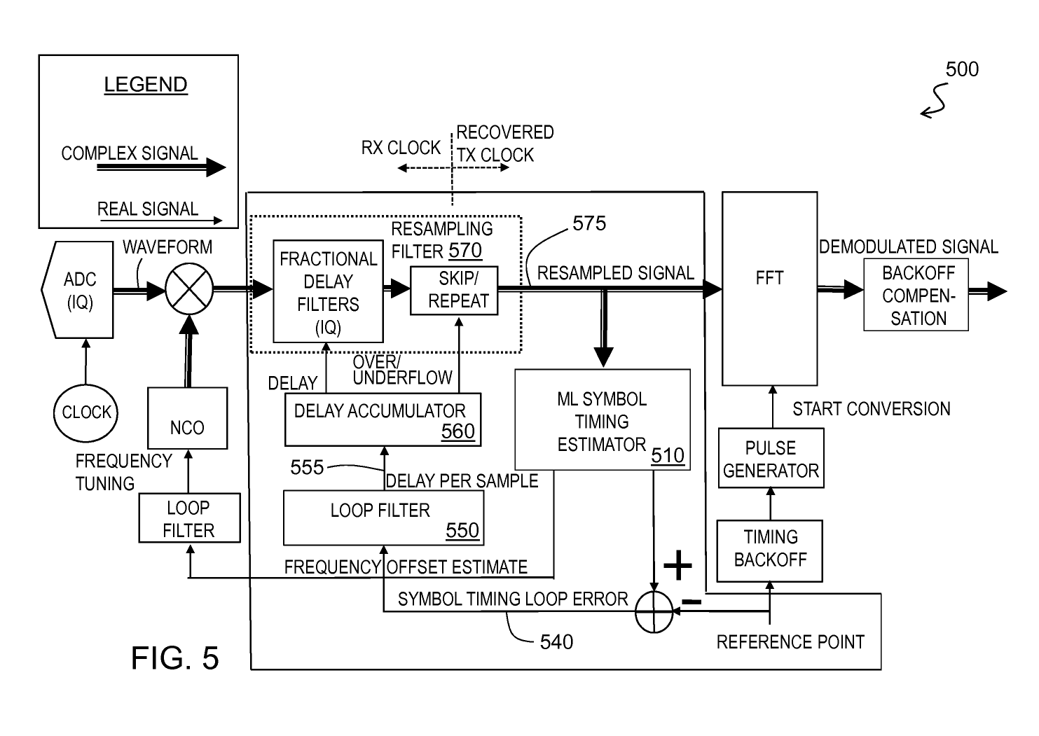

FIG. 5 depicts a functional block diagram embodiment of an exemplary OFDM receiver architecture 500 embodiment comprising an OFDM receiver with SCO compensation. The ML symbol timing estimator 510 described above, may be implemented in a receiver so as to produce information. The information produced by the ML estimator 510 may be used to correct the SCO, CFO, and symbol timing offset, which complete the necessary synchronization requirements for OFDM reception in a mobile wireless receiver, i.e., asynchronous operation between transmitter and receiver. Although an ML symbol timing estimator 510 is described herein for use to generate symbol times, any source of symbol times may be used. In an alternative embodiment, a least squares method, training sequences, synchronization signals, or cyclic prefix correlation may each be used to obtain symbol timing.

The symbol timing loop error 540 may be updated by the symbol timing estimator 510, one time per symbol duration. This error signal may be used by the loop filter 550 to determine the amount of observed delay change per unit sample from SCO. The loop filter 550 averages the loop errors 540 and tracks the timing estimate drift. The loop filter 550 produces a control signal 555 that indicates the estimated SCO. The loop filter output may be accumulated by a delay accumulator 560 at the receiver sampling rate in order to modulate the resampling filter 570.

An ideal resampling filter should produce arbitrary delay. However, in a practical system, the ideal resampling filter does not exist since the available delay values are finite in precision and are upper-bounded. For reasons of practicality, a combination of a fractional delay filter and a skip/repeat component as a resampling component may be considered. The fractional delay filter may be capable of producing delay values between 0 and 1. As the delay may be continuously increased or decreased, the delay will eventually exceed one of these bounds, requiring additional delay correction of one integer sample. The skip/repeat component followed by the fractional delay filter will discard an integer sample if the fractional delay overflows the upper bound 1, and repeat a justified sample if the fractional delay underflows the lower bound 0. Thus, the delay control may become continuous and unbounded.

The resampling filter output 575 passes into the symbol timing estimator 510, so that the new timing window may be determined. This step completes the feedback-control loop to continuously adjust the system to a zero steady-state SCO without modification to the ADC clock.

The resampling process and the delay accumulator operates at sample clock rate, while the control signal 555 to the delay accumulator may not necessarily be updated at the same rate. In one embodiment, the update rate of the symbol timing estimator 510 and loop filter 550 may be slower as long as the estimate can track the symbol timing motion. In the exemplary embodiment, where the ML symbol timing estimator 510 is used, the update rate of the timing estimator and the loop filter update rate equal the symbol duration. For an OFDM system sampling at 30.72 MHz—and containing 2560 samples in each symbol, and assuming a clock uncertainty as large as 100 ppm (part per million)—which equals to about 3 KHz SCO, the symbol timing estimate drifts only ¼ sample every symbol duration. From the drift rate, the SCO may be accurately measured. Since the drift is relatively slow even for a large clock variation, a loop filter, with an averaging performance, may result in a very robust estimate of SCO even under harsh communication environments such as AWGN and multipath. This resampling scheme and loop update mechanism may provide for a wide SCO correction range. This is beneficial to an OFDM receiver because the sample clock tolerance restriction may be greatly reduced without degrading the receiver acquisition performance.

The CFO estimate may be updated by the symbol timing estimator 510, at an update rate of one time per symbol duration. This error signal may be used by the loop filter 550 to determine the amount of frequency correction. The loop filter averages the loop errors and tracks the long term carrier frequency drift. The loop filter may produce a control signal 555 that indicates the estimated CFO. The loop filter output controls the phase increment of a numerically controlled oscillator (NCO), and the received signal is frequency shifted by multiplying the NCO output.

Since the update rate of the CFO estimate equals to the symbol duration, the maximal corrected CFO without ambiguity equals to half of the subcarrier spacing. If CFO of multiple integer of subcarrier spacing is determined, for example, with the aid of pilot signals known to a particular OFDM system, the estimated value may be added to the NCO input so a larger range of CFO may be corrected.

After synchronization, the ICI may be significantly reduced—thus the SNR of the demodulated signal is greatly improved. The resampled signal passes directly into the FFT component, where OFDM demodulation occurs. The effective transform window starts from each reference point plus L samples. The pulse generator block issues a one-cycle pulse that indicates the beginning of each FFT window. The cyclic prefix may be effectively removed by generating the pulse on the trailing edge of the estimated CP boundary for each symbol.

In a practical system, where additional noise exists, the actual FFT window may be slightly shifted toward the guard interval by a few samples; an effect termed the “timing backoff,” and may be characterized by a backoff value. An early FFT window may effectively avoid ISI from the next OFDM symbol. Since the backoff value is known to the receiver, the resulting phase delay may be compensated in the frequency domain by modulating each subcarrier a corresponding phase delay, termed backoff compensation.

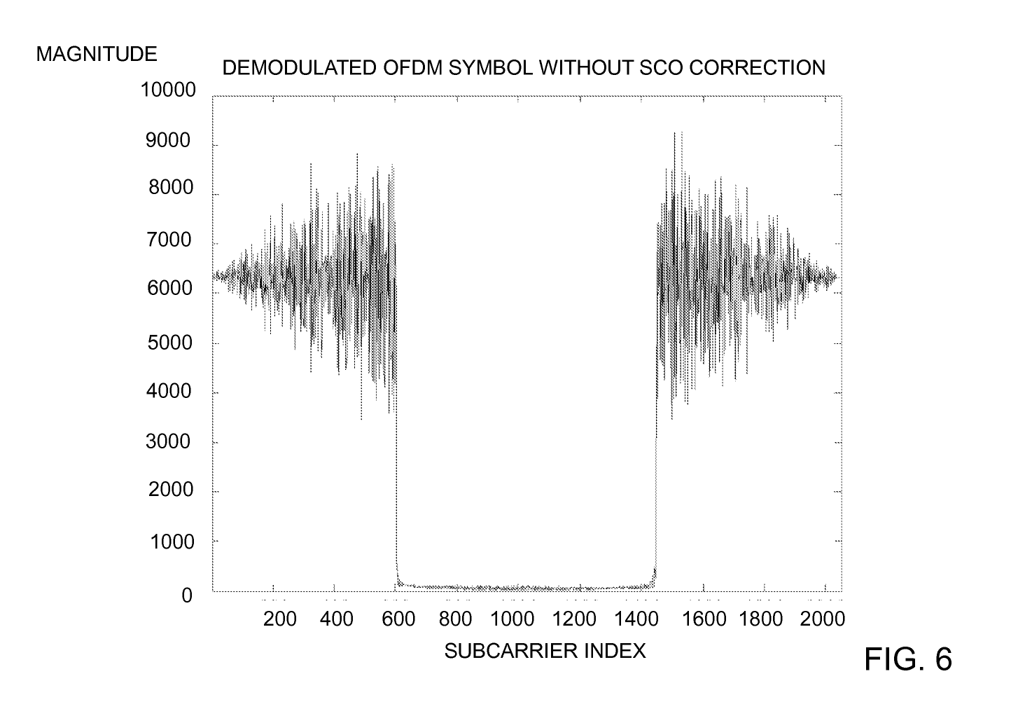

In one embodiment, the receiver architecture shown in FIG. 4 may be implementable in an FPGA. FIGS. 6-9 illustrate exemplary hardware test results where the OFDM configuration used in the exemplary hardware test follows a 20 MHz LTE downlink receiver configuration.

TABLE 1
The OFDM configuration that may be used in a hardware test.

| Channel bandwidth (BW) | 20 MHz |
|---|---|
| Sub-carrier spacing | 15 KHz |
| Sampling frequency fs | 30.72 MHz |
| FFT size | 2048 |
| Occupied sub-carriers | 1200 |
| CP length (extended CP) | 512 |

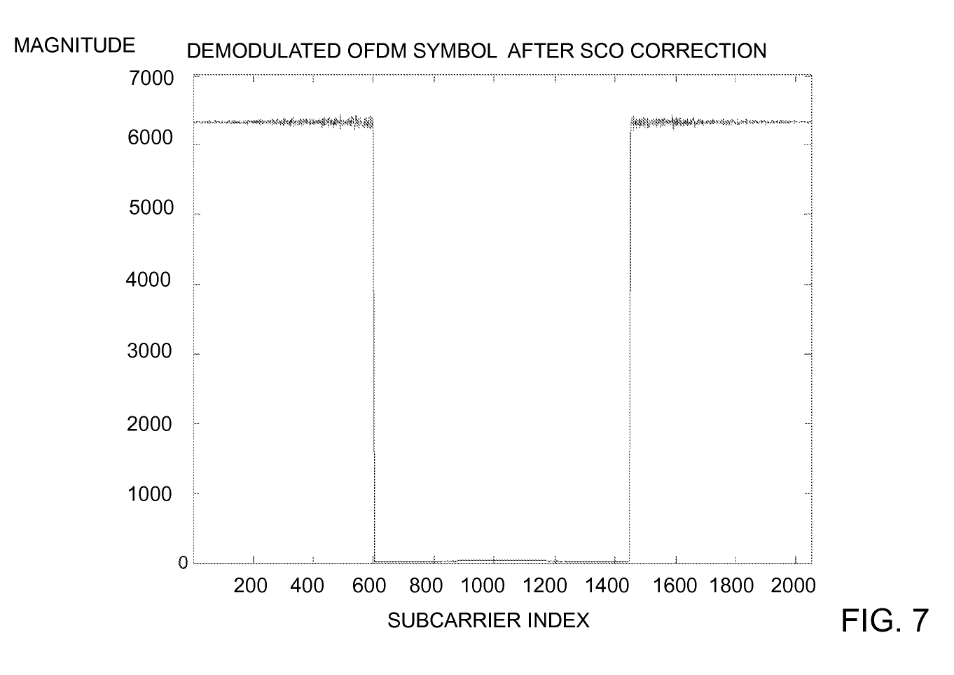

FIGS. 6 and 7 compare the receiver performance with resampling filter and without resampling filter. There is 100 ppm SCO between the transmitter and the receiver. FIG. 6 is a graph depicting a demodulated OFDM symbol without SCO correction, and FIG. 7 is a graph depicting a demodulated OFDM symbol with SCO correction.

In FIG. 6, the resampling filter is bypassed, so that no SCO compensation is performed. For an exemplary OFDM configuration, the QAM symbols occupy FFT bin indices given by l ∈{2, 3, . . . 601, 1449, 1450, . . . , 2048}. Any indices ∉ l contain zeros, such that no power is transmitted. FIG. 6 plots the demodulated OFDM symbol. Bin 1 is the DC component, and bins 601 and 1449 are the outermost subcarriers. Without SCO correction, severe ICI exists.

In FIG. 7, SCO is corrected, and the demodulated OFDM symbol is plotted. In some embodiments, the SCO induced ICI may be significantly reduced via the SCO correction.

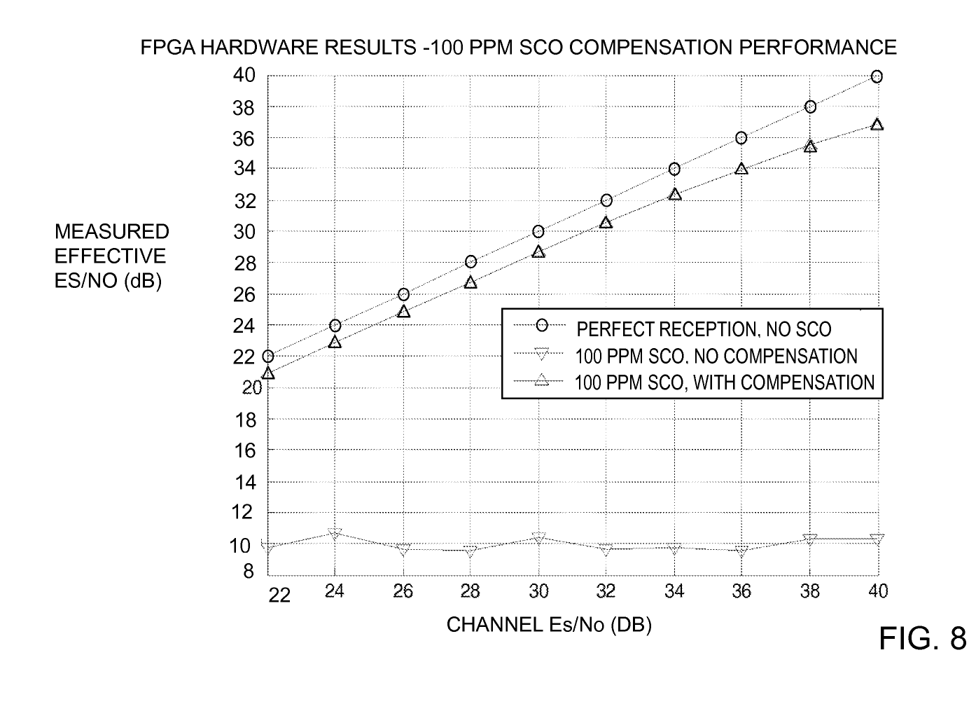

FIG. 8 is a graph depicting the SCO compensation performance as a function of channel Eₛ/Nₒ, i.e., as a function of energy per symbol over noise power spectral density. FIG. 8 compares the performance of a signal impaired with varying levels of AWGN with the performance of the same signal corrupted by a 100 ppm SCO. The measured SNR of the demodulated symbol is averaged over all subcarrier positions for each symbol. Because of the large SCO, the receiver without SCO correction may not be able to maintain reliable synchronization, and may fail even when the received signal has a high SNR. Under the same conditions, the proposed SCO compensation algorithm tracks the clock offset and resamples the signal to allow reliable timing estimation. When using the proposed SCO compensation in the exemplary embodiments, the designer may use lower tolerance clocks, e.g., to save cost, while maintaining a high level of performance. This test illustrates that, when using the proposed SCO compensation method, successful reception may still take place even when the transmitter and receiver are equipped with ±50 ppm clock sources.

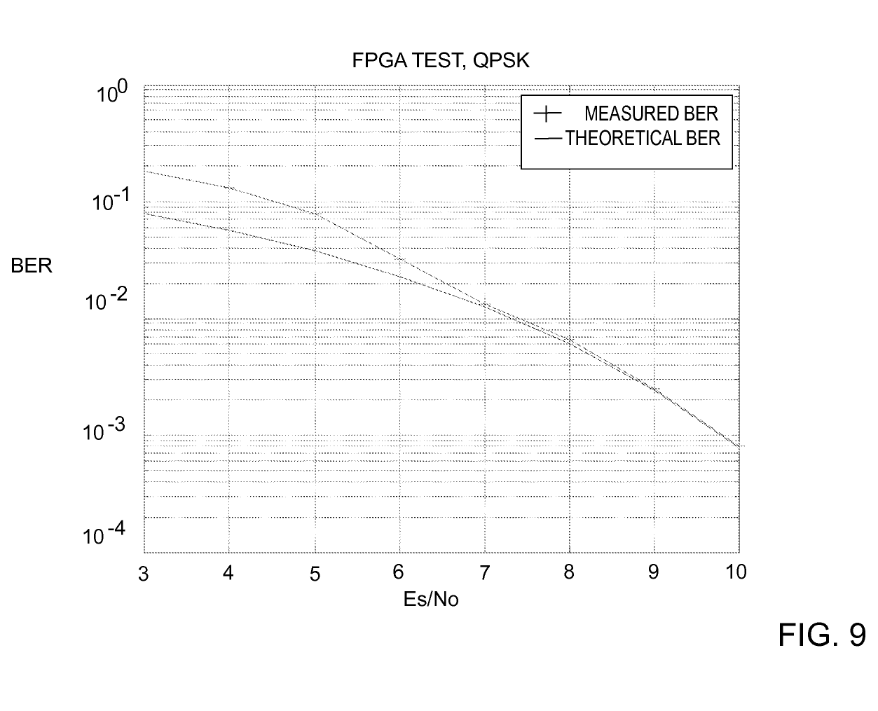

The bit error rate (BER) of an exemplary receiver embodiment is depicted in a graph of FIG. 9, where the minimum Eₛ/Nₒ, i.e., energy per symbol over noise power spectral density, for the synchronization loops to remain locked is 3 dB. FIG. 9 shows the BER performance of the exemplary receiver where above 7 dB Eₛ/Nₒ, the measured BER closely meets the theoretical BER values. Below 7 dB Eₛ/Nₒ the BER performance level is shown as within 2 dB.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. An orthogonal frequency division multiplexing (OFDM) receiver system comprising:
a processor configured to execute a maximum likelihood timing estimator for OFDM symbol timing;
a resampling filter for sampling clock frequency offset correcting via a loop filter, wherein the loop filter is configured to receive a symbol timing loop error and provide, via a delay accumulator input signals to the resampling filter; and
wherein the resampling filter is configured to output a resampled signal for demodulating.

2. The orthogonal frequency division multiplexing (OFDM) receiver system of claim 1 further comprising:
a backoff compensator configured to attenuate inter-symbol interference; and
an OFDM signal demodulator.

3. The orthogonal frequency division multiplexing (OFDM) receiver system of claim 1 wherein the processor is further configured to execute a maximum likelihood timing estimator for carrier frequency synchronization.

4. An orthogonal frequency division multiplexing (OFDM) receiver system comprising:
a processor configured to execute a timing estimator for OFDM symbol timing;
a resampling filter for sampling clock frequency offset correcting via a loop filter, wherein the loop filter is configured to receive a symbol timing loop error and provide, via a delay accumulator input signals to the resampling filter; and
wherein the resampling filter is configured to output a resampled signal for demodulating.

5. The system of claim 4 wherein the timing estimator comprises a least squares timing estimator.
